(19) United States
(12) Patent Application Publication
(10) Pub. No.: US 2023/0411696 A1
(43) Pub. Date: Dec. 21, 2023

(54) COMPOSITION FOR CALCIUM BATTERY ELECTROLYTE, CALCIUM BATTERY ELECTROLYTE, AND CALCIUM BATTERY

(71) Applicant: TOHOKU UNIVERSITY, Sendai-shi (JP)

(72) Inventors: Kazuaki KISU, Sendai-shi (JP); Sangryun KIM, Sendai-shi (JP); Shinichi ORIMO, Sendai-shi (JP)

(73) Assignee: TOHOKU UNIVERSITY, Sendai-shi (JP)

(21) Appl. No.: 18/226,882

(22) Filed: Jul. 27, 2023

Related U.S. Application Data
(63) Continuation of application No. PCT/JP2022/002730, filed on Jan. 25, 2022.

(30) Foreign Application Priority Data
Jan. 28, 2021 (JP) 2021-012000

(51) Int. Cl. H01M 10/0568; H01M 10/0569; H01M 4/02

(52) U.S. Cl. CPC H01M 10/0568; H01M 10/0569; H01M 4/02; H01M 2300/002; H01M 2004/027; H01M 2004/028

(57) ABSTRACT

A composition for a calcium battery electrolyte includes a calcium salt containing at least a calcium atom, a boron atom, and a hydrogen atom and having a cage structure.

### CROSS-REFERENCE TO RELATED APPLICATION

This application is a continuation application of International Application No. PCT/JP 2022/002730, filed on Jan. 25, 2022, and designated the U.S., which claims priority to Japanese Patent application No. 2021-012000, filed on Jan. 28, 2021, the entire contents of each are incorporated herein by reference.

### FIELD

The embodiments of the present disclosure relate to a composition for a calcium battery electrolyte, an electrolyte containing the composition, and a calcium battery containing the electrolyte.

### BACKGROUND

Lithium-ion batteries, which have high energy density, have been applied to storage for portable electronic devices and grid devices. In expectation of forthcoming widespread of electric vehicles and smart grids, demands have arisen for large-scale power storage system. However, current Li-ion battery performance are approaching their theoretical limits. Furthermore, lithium material is unevenly distributed and exhaustion of natural abundance and rise of cost of lithium material have been concerned. For the above, development of batteries using alternative material to lithium has been expected.

In recent years, calcium batteries have been attracted for next-generation secondary batteries. Calcium batteries have high energy densities comparable with those of lithium batteries. Further, rich abundance of calcium allows remarkable cost reduction.

For practical use of calcium batteries, development of a calcium battery electrolyte has been on its way. The performance of a calcium battery is determined in terms of three factors of Ca ion conductivity, plating/stripping stability of Ca ion reaction, and an electrochemical potential window of Ca ion.

Non-patent Document 1 discloses an electrolyte prepared by dissolving a calcium salt Ca(BF₄)₂ in a solvent of a mixture of ethylene carbonate and propylene carbonate (EC+PC). However, a battery containing this electrolyte, which battery functions at 150° C. or higher and also which has poor plating/stripping stability of Ca ion, has a low Coulombic efficiency.

Non-patent Document 2 discloses an electrolyte prepared by dissolving Ca(BF₄)₂ in a solvent of tetrahydrofuran (THF), which exhibits a high Coulombic efficiency on an Au electrode. The electrolyte is compatible with a Ca metal, but has anodic stability as low as 2.4 V vs. Ca²⁺/Ca, which leads to a narrow electrochemical potential window and difficulty in achieving a high voltage.

Non-patent Documents 3 and 4 each disclose an electrolyte prepared by dissolving Ca(4DME)[B(hfip)₄]₂ in a solvent of 1,2-dimethoxyethane (DME). The electrolyte obtains a preferable anode stability (>4.0 V), but generates calcium fluoride CaF₂ on electrodes in the course of charging and discharging because of containing fluorine, resulting in becoming unable to conduct Ca ions.

[Non-Patent Document 1] A. Ponrouch et al., Nature Materials 2016, 15, 169-172

[Non-Patent Document 2] D. Wang et al., Nature Materials 2018, 17, 16-20

[Non-Patent Document 3] Z. Y. Li et al., Energy and Environmental Science 2019, 12, 3496-3501

[Non-Patent Document 4] A. Shyamsunder et al., ACS Energy Lett. 2019, 4, 2271-2276

### SUMMARY

With the foregoing problems in view, at least one of the embodiments of the present disclosure can provide a composition for a calcium battery electrolyte, a calcium battery electrolyte, and a calcium battery free from halogens such as fluorine, high in Ca ion conductivity, stable in Ca ion plating/stripping reaction, and wide in electrochemical potential window.

To Solve the above problem, Inventors synthesized a novel calcium battery electrolyte composition, generated a novel electrolyte containing this composition, and generated a calcium battery including this electrolyte.

### Means to Solve the Problem

According to an aspect of the embodiment, a composition for a calcium battery electrolyte includes: a calcium salt containing at least a calcium atom, a boron atom, and a hydrogen atom and having a cage structure.

According to another aspect of the embodiment, a calcium battery electrolyte includes: a medium for the calcium battery electrolyte; and a calcium salt containing at least a calcium atom, a boron atom, and a hydrogen atom and having a cage structure.

According to an additional aspect of the embodiment, a calcium battery comprising: a positive electrode; a negative electrode; an medium for an electrolyte; and a calcium battery electrolyte a calcium salt containing at least a calcium atom, a boron atom, and a hydrogen atom and having a cage structure.

### BRIEF DESCRIPTION OF DRAWINGS

FIG. 1 is a diagram showing a structure of [CB₁₁H₁₂]⁻;

FIG. 2A shows a Raman spectrum as a result of the material evaluation of Ca(CB₁₁H₁₂)₂, FIG. 2B shows a nuclear magnetic resonance (NMR) spectrum of ¹¹B as a result of the material evaluation of Ca(CB₁₁H₁₂)₂, FIG. 2C shows an NMR spectrum of ¹H as a result of the material evaluation of Ca(CB₁₁H₁₂)₂;

FIG. 3 is a diagram showing a concentration of electrolyte solution (a concentration of calcium salt in each solvent) and a Ca ion conductivity in each solvent;

FIG. 4 is a diagram schematically showing a three-electrode calcium battery for evaluation;

FIG. 5 is a diagram showing a cyclic voltammogram of Ca(CB₁₁H₁₂)₂/THF/DME electrolyte solution;

FIG. 6 is a diagram schematically showing a calcium battery;

FIG. 7 is a diagram showing a Coulombic efficiency determined from the cyclic voltammogram of FIG. 5; and

FIG. 8 is a diagram showing a discharge and charge profile of a calcium-sulfur battery using Ca(CB₁₁H₁₂)₂/THF/DME electrolyte solution.

### DESCRIPTION OF EMBODIMENT(S)

### (A) One Embodiment

Hereinafter, description will now be made in relation to one embodiment of the present disclosure. The following description shows a generic or specific example. The one embodiment is merely an example and the scope of the present disclosure should by no means be limited to the following embodiment.

### (1) Electrolyte

As described above, the performance of a calcium battery is determined in terms of three factors of Ca ion conductivity, plating/stripping reaction stability of Ca ion, and an electrochemical potential window of Ca ion. Specifically, the Ca ion conductivity and the electrochemical potential window of Ca ion are affected by selection of an electrolyte, and a plating/stripping reaction stability of Ca ion is affected by the combination of a positive electrode and a negative electrode. Here, the electrolyte will now be described, and the combination of the positive and negative electrodes will be described below.

Aiming at attaining an electrode having high Ca ion conductivity and a wide electrochemical potential window, Inventors of the embodiments of the present disclosure first synthesized the following novel electrolyte composition, and then prepared an electrolyte solution in which the composition is dissolved.

### (1-1) Composition

The composition may be in a form of a calcium salt, and specifically may be an inorganic calcium salt and/or an organic calcium salt. The salt is preferably an anhydride. A calcium salt is synthesized by combining monovalent anions to a calcium atom of divalent cation.

Examples of the monovalent anion includes Cl⁻, Br⁻, I⁻, BF₄⁻, PF₆⁻, AsF₆⁻, SbF₆⁻, SiF₆⁻, ClO₄⁻, AlCl₄⁻, FSO₃⁻, CF₃SO₃⁻, C₄F₉SO₃⁻, [N(FSO₂)₂]⁻, [N(CF₃SO₂)₂]⁻, [N(C₂F₅SO₂)₂]⁻, [N(FSO₂)(CF₃SO₂)]⁻, CF₃BF₃⁻, C₂F₅BF₃⁻, CB₁₁H₁₂⁻, and the derivatives thereof.

From the viewpoint of electrochemical stability, BF₄⁻, PF₆⁻, ClO₄⁻, AlCl₄⁻, [N(CF₃SO₂)₂]⁻, [N(C₂F₅SO₂)₂]⁻, or CB₁₁H₁₂⁻ may be selected as the monovalent anion. From the viewpoint of solubility, PF₆⁻, FSO₃⁻, [N(CF₃SO₂)₂]⁻, [N(C₂F₅SO₂)₂]⁻, or CB₁₁H₁₂⁻ may be selected as the monovalent anion.

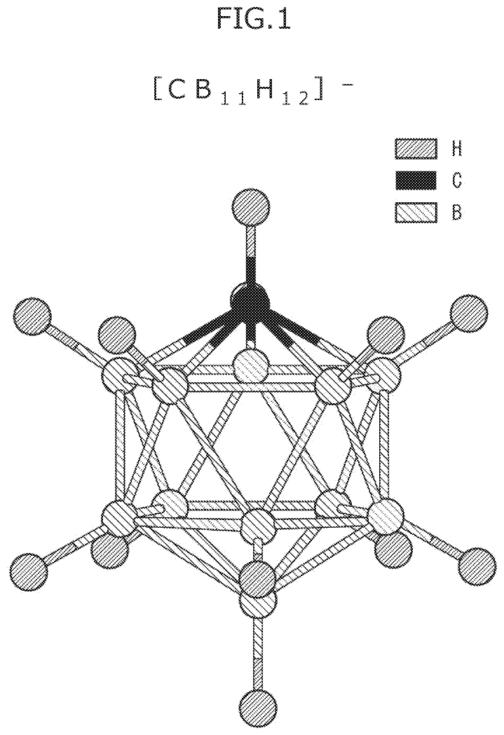

In the present embodiment, Inventors mainly focused on anions of closo-type complex hydride or carborane anions. The closo-type complex hydride is one type of group of boron compounds and is expressed by Formula [BₙHₙ]²⁻. A carborane is also one type of group boron compounds and is a generic name of polyhedral borane having a carbon atom. Each compound has a crystalline structure in the form like a cage (closo-structure; see FIG. 1). The closo structure has boron atoms at respective apexes of the closed polyhedron but does not have a three-center two-electron bond. A carborane group further has a carbon atom bound to a closo-structure.

Examples of an anion pertaining to a carborane are CB₁₁H₁₂, CB₉H₁₀, and CB₇H₈ among which CB₁₁H₁₂ may be preferably selected. Carborane anions are observed to have common features of superior in reduction stability not to reductively decompose on the surface of a calcium metal electrode and of low coordinating with a calcium cation because weakly interacting with a calcium cation. For the above, if another carborane anion is selected in place of CB₁₁H₁₂, similar fine calcium stripping/plating stability would be obtained.

FIG. 1 shows the structure of CB₁₁H₁₂([CB₁₁H₁₂]⁻). As the legend shows, a narrow right-diagonal hatched portion represents a hydrogen atom H; a black portion represents a carbon atom C, and a wide left diagonal hatched portion represents a boron atom B. [CB₁₁H₁₂]⁻ forms a space therein by binding the boron atoms B and the carbon atom C, and this structure is expressed to be a cage structure. By binding hydrogen atoms to the circumference of the cage structure, [CB₁₁H₁₂]⁻ are formed.

The composition of the embodiments of the present disclosure is formed of a calcium salt containing at least a calcium atom, a boron atom, and a hydrogen atom and having a cage structure. This calcium salt contains component expressed by a general formula Ca(CBₙ₋₁Hₙ)₂ (where, n is an integer of four or more). Specifically, the calcium salt may contain a component selected from a group including Ca(CB₁₁H₁₂)₂, and a mixture of Ca(CB₁₁H₁₂)₂ and Ca(CB₉H₁₀)₂. If being a mixed salt, the calcium salt is expressed by a general formula Ca(CB₁₁H₁₂)₂₋ₓ(CB₉H₁₀)ₓ (where, x is an integer of one or more). The following description assumes that the calcium salt is Ca(CB₁₁H₁₂)₂. Calcium salts except for Ca(CB₁₁H₁₂)₂ can be synthesized in the same method as the method below.

Description will now be made in relation to a method of synthesizing Ca(CB₁₁H₁₂)₂. In Step 1, an aqueous solution of the starting material A(CB₁₁H₁₂)ₓ is passed through a cation exchange resin and converted into an aqueous of (H₃O) (CB₁₁H₁₂). The symbol A is exemplified by Li, Na, Cs, Me3NH, or Mg, and the illustrated example uses the starting material satisfying A=Cs and x=1 or 2. In Step 2, the obtained aqueous solution of (H₃O) (CB₁₁H₁₂) is neutralized in the aqueous solution by adding a calcium compound such as Ca(CO₃) or Ca(OH)₂ and consequently, hydrate Ca(CB₁₁H₁₂)₂ is obtained. In Step S3, the obtained hydrate Ca(CB₁₁H₁₂)₂ is heat treated at 160 to 240° C. under vacuum for dehydration and thereby Ca(CB₁₁H₁₂)₂ anhydride is obtained.

### (1-2) Evaluation of Composition

Material evaluation was demonstrated on hydrate Ca(CB₁₁H₁₂)₂ and Ca(CB₁₁H₁₂)₂ anhydride obtained in Steps of the above synthesizing method. Sample 1 was Ca(CB₁₁H₁₂)₂ (hydrate) before subjected to the heat treatment and Sample 2 was Ca(CB₁₁H₁₂)₂ (anhydrate) after subjected to the heat treatment.

The measurement to evaluate the composition and the electrolyte of the present embodiment was conducted under the environment of the temperature of 25° C. (room temperature) and the humidity of 1 ppm or less. In order to avoid contamination of, for example, moisture, the electrolyte was treated in a glovebox filled with inactive gas such as argon.

### Raman Spectral Measurement

In-situ Raman spectral measurement was performed on Samples 1 and 2. This measurement used Raman Spectral instrument (DXR Raman Microscope, product of Thermo SCIENTIFIC INC.).

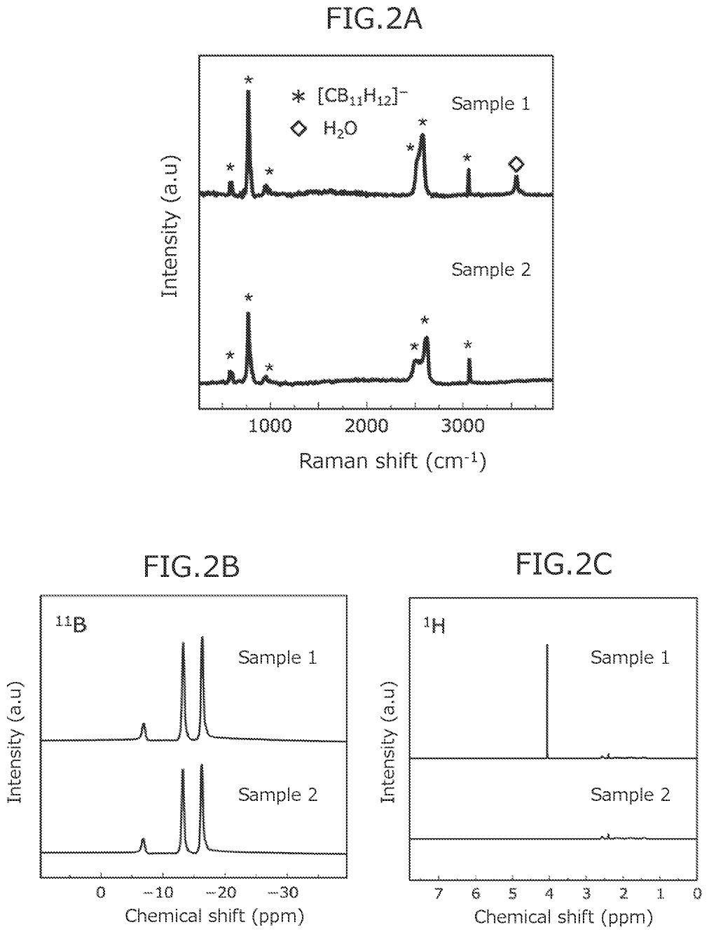

FIG. 2A shows result of spectral analysis. In FIG. 2A, the abscissa indicates a Raman shift, and the ordinate indicates standardized scattering intensity. Between the two spectra, the upper spectrum represents a Raman spectrum of Sample 1, and the lower spectrum represents a Raman spectrum of Sample 2. The mark “*” attached to each spectrum represents a peak of [CB₁₁H₁₂]⁻, and the rhomb mark represents a peak of H₂O. Peaks of [CB₁₁H₁₂]⁻ were observed in both spectra. No H₂O peak was observed in the lower spectrum and therefore Sample 2 was confirmed to be an anhydrite.

### NMR Measurement

Nuclear Magnetic Resonance (NMR) measurement was performed on Samples 1 and 2. This measurement used an NMR instrument (AVANCE III 400, product of Bruker Corporation).

FIGS. 2B and 2C represent result of NMR analyses. In FIGS. 2B and 2C, the abscissas represent chemical shifts, and the ordinates represents standardized signal intensities. FIG. 2B indicates a result of detecting ¹¹B, and FIG. 2C indicates a result of detecting ¹H. Between the spectra in each measurement result, the upper spectrum represents an NMR spectrum of Sample 1, and the lower spectrum represents an NMR spectrum of Sample 2. As shown in FIG. 2B, peaks of ¹¹B were observed in both spectra. On the other hand, no peak of ¹H was observed in the spectra of Sample 2 as shown in FIG. 2C. Also from this result, Sample 2 was confirmed to be an anhydrite through the NMR measurement.

### ICP-OES Measurement

Inductivity coupled plasma optical emission spectrometer (ICP-OES) measurement was performed on Sample 1. This measurement used an optical emission spectrometer instrument (iCAP6500, product of Thermo SCIENTIFIC INC.).

Table 1 shows a composition ratio of Ca(CB₁₁H₁₂)₂. The continuous ratio of contents calcium, boron, and cesium is logically 1:22:0, and was measured to be 1:21.96:1.5×10⁻⁵, which was close to the logical value.

TABLE 1

| | Logical Value | Present Composition |
|---|---|---|
| Calcium content | 1 | 1 |
| Boron content | 22 | 21.96 |
| Cesium content | — | 1.5 × 10⁻⁵ |

The results of multiple measurements confirmed that Ca(CB₁₁H₁₂)₂ was successfully synthesized.

### (1-3) Medium for Electrolyte

A solvent selected as a medium for the electrolyte may be any liquid that can dissolve a calcium salt, but is preferably a non-aqueous solvent. Example of a non-aqueous solvent are ethers, carbonates, glymes. In particular, an ether solvent is more preferable because an ether oxide having negative polarity against a Ca ion less coordinates and therefore an ether solvent can solve a calcium salt at a high concentration. Examples of a low-coordinating ether solvent is 1,2-dimethoxyethane (hereinafter abbreviated to DME), tetrahydrofuran (hereinafter, abbreviated to THF), triglyme, diglyme, tetraglyme, and propylene carbonate.

Normally, DME or THF is used as a solvent for a calcium electrolyte. Considering the above, the present composition Ca(CB₁₁H₁₂)₂ was put into each of DME and THF, but was scarcely dissolved in either solvent. Then, a mixed solution of DME and THF (hereinafter DME/THF mixed solution) was prepared and Ca(CB₁₁H₁₂)₂ was put into this mixed solution. Consequently, Ca(CB₁₁H₁₂)₂ was well dissolved at a concentration of about 0.5 mol/L or higher. In the present embodiment, the DME/THF mixed solution has a volume ratio of DME to THF of 1:1, which however may be different ratio. When Ca(CB₁₁H₁₂)₂ is dissolved in the DME/THF mixed solution, the electrolyte is in a liquid form.

Furthermore, when a mixture (mixed salt) of Ca(CB₁₁H₁₂)₂ and Ca(CB₉H₁₀)₂ was put into the DME/THF mixed solution, the mixed salt was well dissolved at a concentration of about 0.25 mol/L or higher based on each of the salts Ca(CB₁₁H₁₂)₂ and Ca(CB₉H₁₀)₂. When the mixture is dissolved in the DME/THF mixed solution, the electrolyte is in a liquid form.

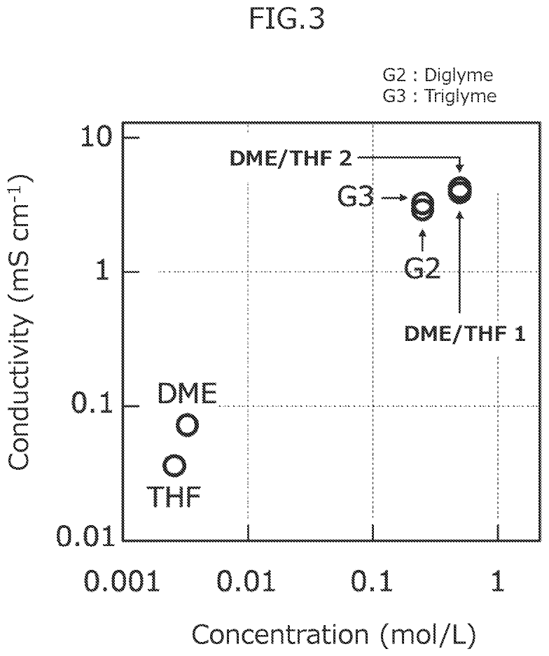

FIG. 3 and Table 2 show solubility of the calcium compound and conductivity of the Ca ion to each solvent. The calcium compounds used in this example were Ca(CB₁₁H₁₂)₂ and Ca(CB₉H₁₀)₂. In FIG. 3, the abscissa indicates a concentration (concentration of the electrolyte solution), and the ordinate indicates conductivity (Ca ion conductivity). In each of simple solvents of DME, THF, Diglyme, Triglyme, Ca(CB₁₁H₁₂)₂ was dissolved in a saturated amount. Furthermore, two sets of the same amount of a mixed solvent DME/THF were prepared, Ca(CB₁₁H₁₂)₂ was dissolved at the concentration of 0.25 (mol/L) in one set (hereinafter, this mixed solvent is referred to as “DME/THF1”) and Ca(CB₁₁H₁₂)₂ and Ca(CB₉H₁₀)₂ were dissolved at the respective concentrations of 0.25 (mol/L) in the other set (hereinafter, this mixed solvent is referred to as “DME/THF2”).

In Table 2, in regard of the simple solvents DME, THF, Diglyme, and Triglyme, the concentrations of electrolyte solution represent a concentration of electrolyte of saturated solutions; in regard of the mixed solvents of DME/THF1, the concentrations of electrolyte solution represents the concentration of an electrolyte solution of Ca(CB₁₁H₁₂)₂ of 0.5 (mol/L); and in regard of the mixed solvents of DME/THF2, the concentrations of electrolyte solution represents the concentration of an electrolyte solution of 0.5 (mol/L) corresponding to the sum of Ca(CB₁₁H₁₂)₂ of 0.25 (mol/L) and Ca(CB₉H₁₀)₂ of 0.25 (mol/L).

TABLE 2

| | Concentration of electrolyte | Ca ion conductivity |
|---|---|---|
| | solution (mol/L) | [ms cm⁻¹] |
| DME | 0.0033 | 0.073 |
| THF | 0.0026 | 0.036 |
| G2 (Diglyme) | 0.25 | 3.1 |
| G3 (Triglyme) | 0.25 | 3.2 |
| DME/THF1 | 0.5 | 4.0 |
| DME/THF2 | 0.5 | 4.4 |

In FIG. 3, data points of the respective solvents are plotted, Diglyme is represented by G2; Triglyme is represented by G3, and the mixed solvents are represented by DME/THF1 and DME/THF2. From FIG. 3 and Table 2, it was confirmed that the simple solvents DME and THF were low in both solubility and ion conductivity, but the mixed solvents DME/THF1 and DME/THF2 were high in both solubility and ion conductivity. Furthermore, it was confirmed that the simple solvents Diglyme and Triglyme similarly to each other obtained preferable values of solubility and ion conductivity, but the mixed solvents DME/THF1 and DME/THF2 obtained further preferable results. Furthermore, it was confirmed that the mixed solvent DME/THF2 obtains higher conductivity than the mixed solvent DME/THF1.

### (1-4) Method for Preparing Electrolyte Solution

The method for preparing the electrolyte solution of the present embodiment is accomplished by dissolving the calcium salt Ca(CB₁₁H₁₂)₂ in the nonaqueous solvent DME/THF mixed solvent. For example, a solvent DME/THF mixed solution in amount obtaining any concentration of an electrolyte solution is added to calcium salt powder, and then stirred the reaction system. This process was conducted under environment of a temperature of 25° C. (room temperature) and a humidity of 1 ppm or less. Stirring was continued overnight until the solution comes to be completely colorless.

### (1-5) Evaluation of Electrolyte Solution

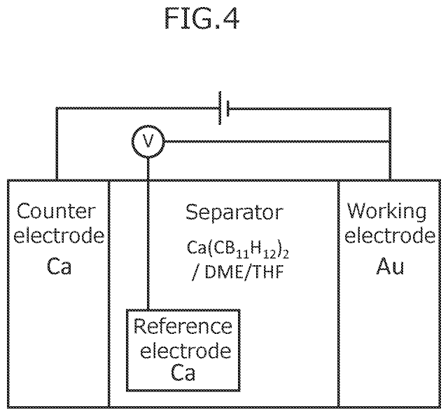

In order to evaluate the characteristic of an electrolyte solution, cyclic voltammetry for stripping/plating Ca ion in the electrolyte was conducted on a three-electrode prototype calcium battery shown in FIG. 4.
=structure of three-electrode prototype calcium battery=
electrolyte solution: DME/THF mixed solution in which Ca(CB₁₁H₁₂)₂ is dissolved
working electrode: metal electrode (e.g., Au electrode)
counter electrode: Ca electrode
reference electrode: Ca electrode

<Cyclic Voltammogram>

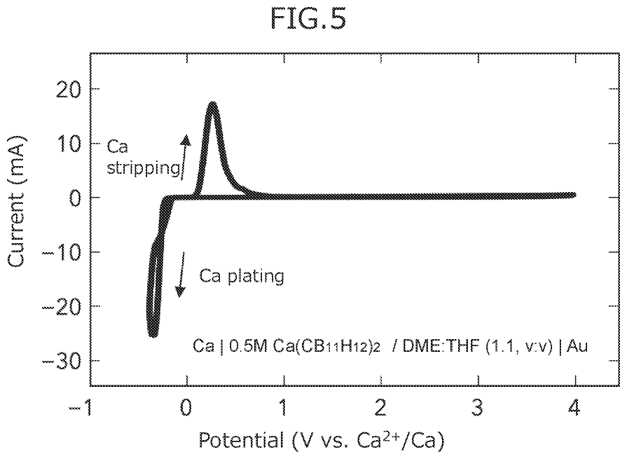

FIG. 5 is a diagram showing a result of measurement of a cyclic voltammogram (CV). In FIG. 5, the abscissa indicates a potential, and the ordinate indicates a current. With respect to the current, no current was obtained in the initial cycle but the current increased as the cycle count increases. The CV curve that increases in the plus direction from 0 V is an oxidation current and represents a Ca ion stripping reaction. In contrast, the CV curve that increases in the minus direction from 0 V is a reduction current and represents a Ca ion plating reaction. The reduction peak current value higher than the oxidation peak current value in absolute value means that the Ca ion pleating reaction more progresses than the Ca ion stripping reaction. Furthermore, a reduction peak current being large and not being sifted to the negative electrode side means the diffusion velocity is identical to the electrode reaction velocity. In addition, in regard of the potential, no current is flowing when the potential is 4 V, which means that the present electrolyte has a wide electrochemical potential window up to 4 V. From this result, it was confirmed that the present electrolyte has stability in Ca ion stripping/plating reaction in the range below 20 mA and has a wide electrochemical potential window.

### (2) Calcium Battery

### (2-1) Overall Structure

The electrolyte of the present embodiment can be applied to a calcium battery. A calcium battery includes a positive electrode, a negative electrode, and a calcium battery electrolyte. As the electrolyte, the one described in the above “(1) Electrolyte” may be appropriately used. The calcium salt may contain the component Ca(CB₁₁H₁₂)₂, and may further contain the component Ca(CB₉H₁₀)₂.

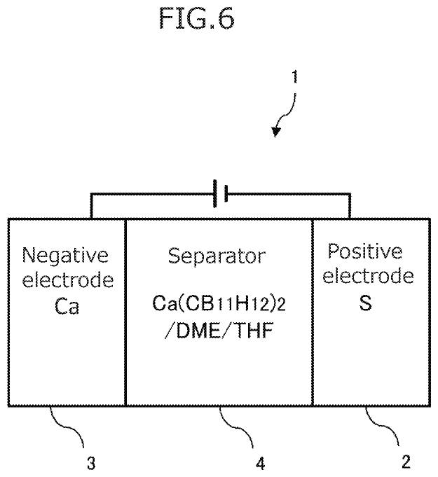

FIG. 6 is a diagram schematically showing an example of a structure of a calcium battery 1. The calcium battery is a rechargeable secondary battery. The calcium battery 1 includes a positive electrode 2, a negative electrode 3, and a separator 4. The separator 4 is disposed between the positive electrode 2 and the negative electrode 3. The calcium battery 1 may take a form of a button, a coin, a cylinder, a square, and a laminate, for example.

The capacity of the calcium battery is determined by the amounts of Ca ion stored in the respective material of the positive electrode and the negative electrode and a difference (i.e., voltage) of the reaction potential between the positive electrode and the negative electrode.

### (2-2) Positive Electrode

The positive electrode 2 may contain a positive electrode active material that is capable of reversibly intercalating and deintercalating Ca ion. Examples of the positive electrode active material include sulfur, titanium sulfide, vanadium oxide, manganese oxide, iron phosphate, vanadium sodium phosphate, calcium molybdate, and prussian blue, among which sulfur is particularly preferable. Sulfur has a large theoretical capacity and is therefore capable of storing five to ten times calcium ion as compared with the above positive electrode active material in an oxide form. Furthermore, sulfur has a relatively low potential to conduct a chemical reaction, which is a demerit that an energy density is not obtained very much but is a merit that a load on an electrolyte solution can be small. For the above, the sulfur positive electrode can obtain a high energy density without decomposing the electrolyte solution.

### (2-3) Negative Electrode

The negative electrode 3 may contain a negative electrode active material that is capable of reversibly intercalating and deintercalating Ca ion. A preferable example of the negative electrode active material includes metal calcium. Use of Ca ion of metal calcium can obtain a large energy density.

Another example of the negative electrode active material include a calcium alloy which may be exemplified by calcium-tin alloy(CaSnₓ), silicon-calcium alloy (CaSiₓ), calcium-zinc alloy (CaZnₓ), calcium-lithium alloy (CaLiₓ), and calcium-sodium alloy (CaNaₓ).

A preferable combination of the positive electrode 2 and the negative electrode 3 is a sulfur (S) positive electrode 2 and a calcium (Ca) negative electrode 3 because of a “theoretical” large capacity ( 1.34 Ah/g) of a calcium metal and the optimal potential of Ca²⁺/Ca contrast thereof. In addition, since the reaction potential 2.5 V vs. Ca²⁺/Ca between sulfur and calcium is adequately lower than the oxidization degrading potential (4V vs. Ca²⁺/Ca or more), prolongation of the lifetime of the calcium battery can be expected.

The positive electrode 2 and the negative electrode 3 of the present example are each preferably a mixture of the corresponding active material ground into grains, conductive material such as acetylene black, carbon black, and graphite, and a binder such as polyvinylidene fluoride or polytetrafluoroethylene. These polymer materials should by no means be limited as far as the materials can bind the active material and the conductive material to obtain the effects of the embodiments of the present disclosure.

### (2-4) Separator

The separator 4 insulates the positive electrode 2 from the negative electrode 3. An electrolyte in a liquid form is impregnated in the separator 4. Examples of material of the separator 4 include a porous film and a nonwoven fabric. More specifically, the separator 4 may be formed of a glass fiber, glass ceramic, polyethylene, polypropylene, cellulose, polyvinylidene fluoride, and mixtures containing two or more of the above materials. The separator may contain electrolyte. The calcium battery 1 of the present example may be obtained by, for example, bringing the separator 4 into contact with (e.g., impregnating in) an liquid-form electrolyte.

### (2-5) Electrochemical Evaluation

The electrolyte of the present example was electrically and chemically evaluated.

<Coulombic Efficiency>

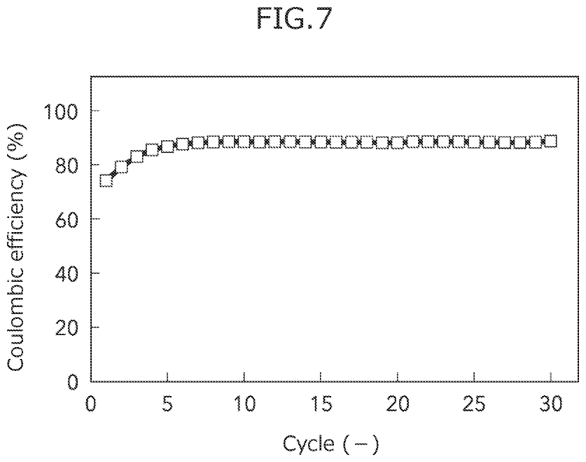

FIG. 7 is a diagram showing a result of plotting the Coulombic efficiency determined from measurement result of the cyclic voltammogram of FIG. 5 on the three-electrode calcium battery (see FIG. 4). In FIG. 7, the abscissa indicates a cycle, and the ordinate indicates a Coulombic efficiency. The Coulombic efficiency of the fifth cycle and the subsequent became constant at 90% and an extremely high Coulombic efficiency were maintained through the overall cycles. This result confirmed that the charged capacity can be used for discharging without loss, and therefore a calcium battery using the present electrolyte is excellent in charging-discharging performance and expects a prolonged lifetime.

Furthermore, the measurement was performed on the following two-electrode prototype calcium battery 1 (see FIG. 6).
=two-electrode prototype calcium battery 1=
electrolyte solution: DME/THF mixed solution in which Ca(CB₁₁H₁₂)₂ is dissolved
negative electrode material: Ca metal
positive electrode material: sulfur (S)

<charging-discharging profile>

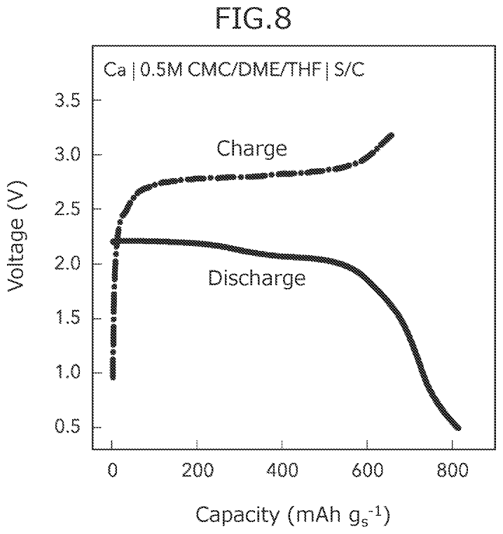

FIG. 8 shows a charging profile, and specifically shows a result of measuring the charging-discharging cycling performance of the electrolyte having an electrochemical potential window of 1.0 to 3.2 V. In FIG. 8, the abscissa indicates the capacity, and the ordinate indicates a voltage. Between two lines, the line indicated by “charge” is a current-voltage curve when charging the battery, and the line indicated by “discharge” is a current-voltage curve when discharging battery. Since reversibility can be read from this result, t it was confirmed that the calcium battery using the present electrolyte can be charged and discharged.

### (B) Miscellaneous

The embodiments of the present disclosure can provide a composition for a calcium battery electrolyte, a calcium battery electrolyte, and a calcium battery that is free from halogens such as fluorine, high in Ca ion conductivity, stable in Ca ion stripping/plating reaction, and wide in electrochemical potential window. The electrolyte composition and the electrolyte of the embodiments of the present disclosure can be used for a calcium battery.

Throughout the specification and the claims, the indefinite article “a” or “an” does not exclude a plurality.

All examples and conditional language recited herein are intended for the pedagogical purposes of aiding the reader in understanding the disclosure and the concepts contributed by the inventor to further the art, and are not to be construed limitations to such specifically recited examples and conditions, nor does the organization of such examples in the specification relate to a showing of the superiority and inferiority of the disclosure. Although one or more embodiments of the present disclosures have been described in detail, it should be understood that the various changes, substitutions, and alterations could be made hereto without departing from the spirit and scope of the disclosure.

What is claimed is:

1. A composition for a calcium battery electrolyte comprising:
a calcium salt containing at least a calcium atom, a boron atom, and a hydrogen atom and having a cage structure.

2. The composition according to claim 1, wherein
the calcium salt contains a component expressed by a general formula Ca(CBₙ₋₁Hₙ)₂ (where n is an integer of four or more).

3. The composition according to claim 2, wherein
the calcium salt contains a component selected from a group including Ca(CB₁₁H₁₂)₂ and a mixture of Ca(CB₁₁H₁₂)₂ and Ca(CB₉H₁₀)₂.

4. The composition according to claim 3, wherein
the calcium salt contains a component Ca(CB₁₁H₁₂)₂.

5. The composition according to claim 4, wherein
the calcium salt further contains a component Ca(CB₉H₁₀)₂.

6. A calcium battery electrolyte comprising:
a medium for an electrolyte; and
a calcium salt containing at least a calcium atom, a boron atom, and a hydrogen atom and having a cage structure.

7. The calcium battery electrolyte according to claim 6, wherein
the calcium salt contains a component expressed by a general formula Ca(CBₙ₋₁Hₙ)₂ (where n is an integer of four or more).

8. The calcium battery electrolyte according to claim 7, wherein
the calcium salt contains a component selected from a group including Ca(CB₁₁H₁₂)₂ and a mixture of Ca(CB₁₁H₁₂)₂ and Ca(CB₉H₁₀)₂.

9. The calcium battery electrolyte according to claim 8, wherein
the calcium salt contains a component Ca(CB₁₁H₁₂)₂.

10. The calcium battery electrolyte according to claim 9, wherein
the calcium salt further contains a component Ca(CB₉H₁₀)₂.

11. The calcium battery electrolyte according to claim 6, wherein
the medium is a mixed solution of 1,2-dimethoxyethane and tetrahydrofuran.

12. The calcium battery electrolyte according to claim 11, wherein
the mixed solution has a volume ratio of 1,2-dimethoxyethane to tetrahydrofuran of 1:1.

13. A calcium battery comprising:
a positive electrode;
a negative electrode; and
a calcium battery electrolyte comprising:
a medium for an electrolyte; and
a calcium salt containing at least a calcium atom, a boron atom, and a hydrogen atom and having a cage structure.

14. The calcium battery according to claim 13, wherein the calcium battery electrolyte is impregnated in a separator that insulates the positive electrode from the negative electrode.

15. The calcium battery according to claim 13, wherein
the positive electrode is formed of sulfur; and
the negative electrode is formed of a calcium metal.

16. The calcium battery electrolyte according to claim 7, wherein
the medium is a mixed solution of 1,2-dimethoxyethane and tetrahydrofuran.

17. The calcium battery electrolyte according to claim 8, wherein
the medium is a mixed solution of 1,2-dimethoxyethane and tetrahydrofuran.

18. The calcium battery electrolyte according to claim 9, wherein
the medium is a mixed solution of 1,2-dimethoxyethane and tetrahydrofuran.

19. The calcium battery electrolyte according to claim 10, wherein
the medium is a mixed solution of 1,2-dimethoxyethane and tetrahydrofuran.

20. The calcium battery according to claim 14, wherein
the positive electrode is formed of sulfur; and
the negative electrode is formed of a calcium metal.
